(19) United States
(12) Patent Application Publication
(10) Pub. No.: US 2010/0146533 A1
(43) Pub. Date: Jun. 10, 2010

(54) Listing Advertisement Transmitting Device and Method

(75) Inventors: Hisashi Matsunaga, Tokyo (JP); Hideaki Haruta, Tokyo (JP); Hiroki Noda, Tokyo (JP)

Correspondence Address: SAMPSON & ASSOCIATES, P.C., 50 CONGRESS STREET, BOSTON, MA, 02109, US

(73) Assignee: DENTSU INC., Tokyo (JP)

(21) Appl. No.: 12/521,285

(22) PCT Filed: Dec. 27, 2007
(86) PCT No.: PCT/JP2007/001489

§ 371 Date: Feb. 8, 2010

(30) Foreign Application Priority Data
Dec. 27, 2006 (JP) 2006-353438

(51) Int. Cl. H04H 20/14; G06Q 10/00; G06Q 30/00; G06Q 50/00

(52) U.S. Cl. 725/22; 705/14.43; 705/14.52

(57) ABSTRACT

[Problems] To provide a technique of fusing advertisement through broadcasting with that through a network out of advertisement media, especially a technique of producing a high advertisement effect by automatically synchronizing the advertisement timing and by optimizing the display form.

[Means for Solving Problems] A listing advertisement transmitting device connected to a user terminal through a network and adapted for displaying a listing advertisement the setting of the advertisement charge of which is different with the display form of the user terminal is set. The device comprises a broadcast information database having storage means in which broadcast information about at least the broadcast content and the broadcast time of the broadcast program and advertisement transmitted over a broadcast medium is stored, an advertisement condition database having storage means in which the corresponding advertisement and the transmitting condition is stored depending on the broadcast content, a listing condition database having storage means in which listing conditions of the display form and the advertisement charge are stored, display form parameter setting means for setting a display form parameter representing the display form and the advertisement charge under the listing condition when the present time acquired from time measuring means meets the transmission condition including at least the condition relation between the advertisement information and the present time, and advertisement transmitting means for transmitting the advertisement data from the advertisement condition database to the user terminal through the network according to the display form parameters.

### TECHNICAL FIELD

The present invention relates to a listing advertisement transmission device and method connected to a user terminal device through a network and capable of transmitting advertisement data to be outputted in the user terminal device and particularly to a technique relating to timing for transmitting the advertisement data and a display mode thereof.

### BACKGROUND ART

Technological innovation in the broadcasting communication field has been remarkable in recent years, and modes of television viewing in general households have been largely changed due to a wide spread of the Internet and switching to digital TV broadcasting. Particularly, provision of an access function to the Internet in a digital TV set and offering of products in which the digital TV set is integrated with a personal computer or video game have increased opportunities for users to use TV and the Internet at the same time.

When a commercial on a product is on TV, for example, a user who gets interested in the product searches its information on the Internet in many cases, and it is known that after the commercial, access to a web site of the product on the Internet is increased. Recently, access to a URL (Uniform Resource Locator) is promoted for users by presenting a specific URL during the commercial.

A trial to effectively integrate a broadcasting media including TV and a network including the Internet has been made. On the other hand, users spend a long time in using the Internet, with which the advertisement market on the Internet has rapidly expanded, and advertisers have positioned the Internet as one of important advertising media.

Selection of the advertising medium in general is designed such that the most effective advertising strategy can be used by combining various media as appropriate through an advertising agency. The advertising agency is demanded to make a proposal based on sophisticated information collection and know-how on how to combine which media at what ratio, how to distribute the advertising budget and the like in the Internet in addition to TV, radio, newspaper, and magazine on the basis of researches on various viewers and experiences.

Such an advertising strategy has been formulated on the basis of a system uniquely owned by the advertising agency, the experiences and hunches, and synergistic utilization of advertising media has been only made artificially in measures such as presentation of URL in the commercials as described above or notification of a period of newspaper advertisements in the commercial, for example.

However, by integrating both the advertisements on a more real-time basis in the coexistence of TV and the Internet as mentioned above, higher advertising effectiveness can be expected. Such a combination of media is also suggested in Non-Patent Document 1, for example.

Such a technique is relatively easy in a single Internet terminal and a single digital television, and some proposals have been already made. In the technique disclosed in Patent Document 1, for example, a system for providing information relating to contents broadcast in a program/CM desired by audiences by the same means in the program/CM in digital broadcasting is proposed. This technique discloses provision of commercial transaction means group including content information searching means for searching contents information recorded in a database relating to the program/CM contents from programs/CM being received and goods transaction means for making goods transaction by searching goods information recorded in the database relating to mail-order sale associated with the contents information obtained by the contents information searching means and homepage connecting means for connecting to a homepage with a homepage address set in the contents information.

Patent Document 2 pays attention to the fact that there are many banners not relating to the searched TV program in a search using EPG in digital broadcast, which does not attract interest of users, and discloses a technique in which needs of an advertising client matches needs of a user. For that purpose, an information acquisition method is provided such as an advertisement using the Internet in which a user connects to a relay server through the Internet from an Internet-ready terminal machine owned by the user, searches a program using an EPG function that enables reaching the information page of the desired TV program using a search function toward a deep layer from a top screen through the relay server, and pastes an advertisement such as a banner advertisement relating to the program in a display screen of the searched program information so that the information in the deep layer can be obtained sequentially by clicking the advertisement information.

Presentation of advertisements on Internet sites are known, and various systems and methods are provided, and Patent Document 3, for example, discloses a technique relating to transition to a WWW server of an advertiser from a banner advertisement.

On the other hand, in search sites or goods-sales sites accessed by many users, advertisement effectiveness is varied depending on display modes such that where on a screen or what size an advertisement is displayed, how often an advertisement is displayed and the like, and advertising rates are set finely according to the display mode or user action. Moreover, in the search sites, advertising rates are set finely for each word to be searched regarding which advertisement is displayed on a screen displaying the search result.

These advertisements generally include advertisement called listing advertisement. For example, such an advertisement form is employed that for a searched word of a “car dealer”, bids are invited from a plurality car dealers (advertisers) for an advertising rate, and the car dealers are displayed in a list from the one with the highest rate in the network advertisement. A technique disclosed in Patent Document 4 is one of them.

### CITATION LIST

Non-Patent Document 1: AD-Topic <Internet Advertisement> “System Reinforcement by Advertizing Companies in Reactivated Business—Combination with Mass Media as Key—” Business and Advertisement, April 2005

Patent Document 1: Japanese Patent Laid-Open No. 2002-290947

Patent Document 2: Japanese Patent Laid-Open No. 2002-245330

Patent Document 3: Japanese Patent Laid-Open No. 2003-141410

Patent Document 4: Japanese Patent Laid-Open No. 2006-508472 (Translation of PCT Application)

### SUMMARY OF INVENTION

The present invention was made in view of the above problems of the prior art and has an object to provide a technique to integrate advertisement through broadcasting with that through a network out of advertisement media and particularly a technique of producing high advertisement effectiveness by automatically synchronizing the advertisement timing and by optimizing a display mode.

In order to solve the above problems, the present invention uses the following means. That is, the present invention is characterized in that in a listing advertisement transmitting device connected to a user terminal device through a network and displaying listing advertisements whose advertising rates are different depending on a display mode at the user terminal device, the device is provided with a broadcast information database storing broadcast information relating to at least broadcast contents and broadcast time delivered on a wired or wireless broadcast medium intended to be directly received by the public in storage means, an advertisement condition database storing corresponding advertisement data and transmission conditions thereof according to the broadcast contents in the storage means, a listing condition database storing listing conditions relating to the display mode and the advertising rate in the storage means, the transmission conditions include at least a condition relation between the advertisement information and a current time, display-mode parameter setting means for setting a display mode parameter including the display mode and the advertising rate according to the listing condition if the current time obtained from clocking means satisfies the transmission condition, and advertisement transmitting means for transmitting the advertisement data from the advertisement condition database to the user terminal device through the network according to the display mode parameter.

In the network advertisement transmitting device, such a case may be included that the broadcast programs are broadcast shows of news, sports, performance, entertainment, discussion and the like.

If the broadcast program is a broadcast show, goods information extracting means for extracting information on goods relating to goods or service from the broadcast contents of the broadcast show may be provided so that the extracted information is made as advertisement contents, the broadcast information at that time as advertisement information, and the broadcast information database at that time as an advertisement information database.

A case in which the broadcast program is an advertisement is included, and in that case, the broadcast contents may be advertisement contents, the broadcast information may be advertisement information, and the broadcast information database may be the advertisement information database.

The listing advertisement transmitting device may be configured to be provided with advertisement effectiveness determining means for determining advertisement effectiveness of an advertisement transmitted on the broadcast medium at least from the advertisement information and listing condition setting means for setting or updating the listing condition according to a determination result of the advertisement determining means.

In the listing advertisement transmitting device, user action acquisition means for acquiring action information of a user to the listing advertisement is provided, and the advertisement effectiveness determining means may determine the advertisement effectiveness from the advertisement data and the display mode parameter when it is transmitted and the action information.

The listing advertisement transmitting device may be configured to be provided with at least any one of receiving means for receiving the broadcast, image recognition means for image/video received by the receiving means or sound recognition means for sound received by the receiving means and advertisement information extracting means for extracting at least advertisement contents from a recognition result of the image recognition means or sound recognition means, and the advertisement information is stored in the advertisement information database simultaneously with the broadcast of the advertisement.

The broadcast media may be TV broadcast or radio broadcast.

The advertisement data may be at least any one of text data, image data, video data or sound data constituting listing advertisement.

The network may be the Internet.

In the invention described in claim 8, the network may be a cellular phone line or PHS phone line and the user terminal device may be its phone terminal.

In the invention described in claim 9, the listing advertisement transmitting device may be a search site server provided with a search engine of the Internet, and the advertisement data may be presented on the search site screen.

Also, the present invention can provide the following advertisement transmitting method. That is, the method is a listing advertisement transmitting method of a computer in a listing advertisement transmitting device connected to a user terminal device through a network and displaying listing advertisements whose advertising rates are different depending on a display mode at the user terminal device, provided with an advertisement information database storing broadcast information relating to at least broadcast contents and broadcast time of broadcast delivered on a wired or wireless broadcast medium intended to be directly received by the public in storage means, an advertisement condition database storing corresponding advertisement data and transmission conditions thereof according to the broadcast contents in the storage means, and a listing condition database storing listing conditions relating to the display mode and the advertising rate in the storage means in advance, the transmission conditions including at least a condition relation between the advertisement information and a current time, and may be configured such that a display-mode parameter setting step in which display-mode parameter setting means of a computer sets a display mode parameter including the display mode and the advertising rate according to the listing condition if the current time obtained from clocking means satisfies the transmission condition and an advertisement transmission step in which advertisement transmitting means of a computer transmits the advertisement data from the advertisement condition database to the user terminal device through the network according to the display mode parameter are provided.

Such a case may be included that the broadcast programs are broadcast shows of news, sports, performance, entertainment, discussion and the like. If the broadcast program is a broadcast show, a goods information extracting step in which goods information extracting means of a computer extracts information on goods relating to an article or service from the broadcast contents of the broadcast show may be provided before the advertisement transmission step, and the extracted information may be made as advertisement contents, the broadcast information at that time as advertisement information, and the broadcast information database at that time as an advertisement information database.

A case in which the broadcast program is an advertisement is included, and in that case, the broadcast contents may be advertisement contents, the broadcast information may be advertisement information, and the broadcast information database may be the advertisement information database.

In the listing advertisement transmitting method of a computer, it may be configured that an advertisement effectiveness determination step in which the advertisement effectiveness determining means of a computer determines advertisement effectiveness of an advertisement transmitted on a broadcast medium at least from the advertisement information and a listing condition setting step in which the listing condition setting means of a computer sets or updates the listing condition according to a determination result of the advertisement determining means are provided.

In the listing advertisement transmitting method of a computer, it may be so configured that a user action acquisition step in which the user action acquisition means of a computer acquires user action information to the listing advertisement and an advertisement effectiveness determination step in which the advertisement effectiveness determining means determines advertisement effectiveness from the advertisement data and the display mode parameter when it is transmitted and the action information are provided, and the listing condition setting step is executed.

In the listing advertisement transmitting method of a computer, it may be so configured that at least any one of a broadcast receiving step in which the receiving means receives the broadcast, an image recognition processing step in which the image recognition means of a computer recognizes a received image/video or a sound recognition processing step in which the sound recognition means of a computer recognizes received sound, and a broadcast information extracting step in which broadcast information extracting means of a computer extracts at least broadcast contents from the recognition result are provided, and the broadcast information is stored in the broadcast information database simultaneously with the broadcast.

The broadcast media may be TV broadcast or radio broadcast.

The advertisement data may be at least any one of text data, image data, video data or sound data constituting the listing advertisement.

The network may be the Internet.

The network is a cellular phone line or PHS phone line and the user terminal device may be its phone terminal.

It may be so configured that the listing advertisement transmitting device is a search site server provided with a search engine of the Internet, and the advertisement data is presented on the search site screen.

Since the present invention is constituted as mentioned above, the following working effects are exerted. That is, in the present invention, broadcast contents transmitted at the current time can be known by referring to the broadcast information database, and the advertisement data can be transmitted according to the transmission conditions defined according to the broadcast contents.

In the above, if the broadcast program is a show, the advertisement can be transmitted according to the contents of the show. If, for example, news relating to a hybrid car is to be broadcast, the advertisement data on the hybrid car can be transmitted.

Also, contents of articles or goods relating to a show can be extracted from the contents of the show by the goods information extracting means. If a special program regarding a state-of-art engine is to be broadcast, goods information on goods relating to the engine such as automobiles and motorcycles, service relating to engine tune-up and the like is extracted, and the advertisement according to that can be transmitted.

According to this configuration, since the advertisement can be transmitted on the network according to a broadcast program on a broadcast medium, if a user who took interest in the advertisement contents on the broadcast medium makes a search about in on the network, chances of contact with the advertisement is particularly increased, which can improve advertisement effectiveness.

For example, it is known from the advertisement information database that CM of an advertisement is placed at a certain time on TV, and by defining in the transmission condition transmission during a period from 1 minute to 15 minutes after the CM is transmitted, the advertisement transmitting means can present a banner advertisement at a part of a web page in that time zone.

If a user takes interest through the CM on TV and makes an access to a web page such as a search site and a goods sales site, the banner advertisement is displayed just at the timing, and the user can easily access the information. Naturally, the advertiser can obtain high advertisement effectiveness along with the TV CM, and an advertisement amount can be suppressed during time when there is less access from users, which contributes to reduction in advertising cost and optimization.

In addition, the present invention can optimize the display mode of the advertisement. For example, since the display mode and advertizing rate in the listing advertisement are set by the display-mode parameter setting means when the transmission condition is satisfied, by defining either of the display mode or advertising rate in advance, the optimal advertisement display mode desired by the advertiser can be realized. Specifically, if the transmission condition is satisfied, the display mode defined in the listing condition such as display on the uppermost row is set by the display-mode parameter setting means, and the advertisement transmitting means transmits the advertisement data so that the display is made in that mode.

If the advertising rate is set in the listing condition, the advertisement data can be transmitted in a bid condition that 1 click equals 50 yen, for example. By defining detailed setting in the listing condition, the display mode at that time can be managed appropriately in addition to the synchronization with the advertisement on the broadcast by the transmission condition.

At that time, by determining advertisement effectiveness on broadcast by the advertisement effectiveness determining means, the display mode can be set optimally on the basis of the information acquired from the advertisement information such that the priority rank of the listing advertisement is raised when the advertisement frequency to a user reaches 5 times, for example.

Moreover, the user action to the listing advertisement can be grasped by the user action acquisition portion, the advertisement effectiveness can be determined on the basis of the action information and the display mode at that time, and moreover, contribution can be made to optimization of the display mode.

Also, by providing the advertisement information extracting means for extracting the advertisement contents placed on the broadcast, the transmission condition and the listing condition can be changed on a real time basis. Since there is no need to register advertisement contents or the like placed in the advertisement information database in advance, the present invention can be applied to a case of unscheduled advertisements.

### DESCRIPTION OF EMBODIMENTS

An embodiment of the present invention will be described below referring to the attached drawings. FIG. 1A is an entire configuration diagram of a system (1) using a listing advertisement transmitting device (this device) (10) according to the present invention. The advertisement transmitting device (10) is connected to the Internet (2), and a plurality of user terminal devices (3) (4) to which the advertisement is transmitted are connected to the Internet. A configuration of this network is as known.

The network of the present invention is not limited to the Internet, but arbitrary networks including a cable network in a limited area, a cellular phone network, a PHS network and the like can be used. The user terminal device takes a corresponding terminal configuration according to the type of the network. For example, if the network is the cellular phone network, the user terminal device is a cellular phone terminal, and a configuration to connect the cellular phone terminal to a unique network (“i-mode” (registered trademark) service provided by NTT DoCoMo Inc., for example) is known.

Also, FIG. 1B shows a system configuration of TV broadcast as an example of the broadcast media of the present invention. As shown in the figure, a TV signal (6) is transmitted by radio from a TV broadcast station (5), and a TV set (7) installed in a household receives it and outputs video (including sound. The same applies to the following). In the TV broadcasting, transition from analog broadcasting to digital broadcasting has progressed recently, and a transmitted TV signal has changed from an analog signal to a digital signal. In the case of the digital signal, various types of attached information is transmitted with video, and electronic program tables or attached advertisement information, weather information, traffic information and the like are also transmitted, for example.

As the broadcast media according to the present invention, media called mass media in general to be transmitted to the public in a wide range is suitable, and its typical example is TV broadcast and radio broadcast. The public directly receives it through TV sets or radio sets. Also, wired broadcast media such as cable TV, wired music broadcast and the like and broadcast media for delivering programs through the Internet can be used as the broadcast media.

The broadcast through the Internet is divided into the one for delivering programs at once and the other for delivering programs on demand according to an instruction from a user, and either of them are applicable. That is, since advertisement broadcast time contained in the advertisement information used in the present invention is a concept including not only the units of second, minute and hour but also certain periods of time such as the units of day, week and month, there is no problem even if the advertisement time gains/delays by the unit of second, minute or hour in accordance with the program time as long as the advertisement is sent during this period. In the Internet broadcast, delivery of image (including both moving images and still images) and sound is possible in addition to video delivery.

FIG. 2 shows a configuration diagram of the device (10). The device (10) is configured the most easily by a known personal computer and the following description will be made based on that. But an exclusive hardware may be used or the device may be incorporated as a part of a server device as will be described later.

In the device (10), as is known, hardware such as a CPU (100) for governing calculation processing, information processing and the like, a network adapter (110) for connection with the Internet (2), a hard disk (120) for storing various types of information such as a database, a monitor (130) for screen display, a keyboard (140) for receiving inputs from a user and the like as well as a memory (150) operating with the processing in the CPU (100) are provided.

The hard disk (120) is provided with an advertisement information database (hereinafter referred to as advertisement information DB) (121), an advertisement condition database (hereinafter referred to as advertisement condition DB) (122), and a listing condition database (hereinafter referred to as listing condition DB) (123). Contents of each database will be described later.

### First Embodiment

In the first embodiment of the present invention, a clocking portion (101) for clocking a current time by an oscillator built in the CPU (100), an advertisement transmission portion (105), and a display-mode parameter setting portion (107) are provided. This is the simplest mode of the present invention. FIG. 3 shows a processing flowchart of the first embodiment. That is, from advertisement information according to TV commercials in the advertisement information DB (121), a transmission condition in the advertisement condition DB (122), and a current time obtained at the clocking portion (101), the advertisement transmission portion (105) determines if the transmission condition is satisfied or not (S10), and if satisfied, a display mode parameter is set (S11: display-mode parameter setting step) referring to the listing condition DB (123), and the advertisement data is transmitted (S12) on the basis of it (advertisement transmission step). The advertisement information in the present invention refers to advertisement through the broadcast media, and the advertisement data refers to the advertisement in the network. In order to facilitate discrimination below, the advertisement information might be referred to as CM information and the advertisement contents as CM contents.

Each processing will be described below in detail. In the present invention, the CM information according to the CM contents and broadcast time is stored in advance in the advertisement information DB (121), which is an information table as shown in Table 1 as an example.

TABLE 1
Transmission condition

| | Advertisement | Advertisement | Transmission | Transmission | Transmission |
|---|---|---|---|---|---|
| 1 | contents | data | start timing | end timing | destination |
| 2 | Product A1 | Banner data 1 | 30 seconds | 15 minutes | Banner |
| | | | after | after | listing |
| | | | advertisement | advertisement | region 1 |
| | | | end | end | |
| 3 | Product A1 | Banner data 2 | 15 minutes | 5 hours after | Banner |
| | | | after | advertisement | listing |
| | | | advertisement | end | region 2 |
| | | | end | | |
| 4 | Product A2 | Banner data 3 | 30 seconds | 15 minutes | Banner |
| | | | after | after | listing |
| | | | advertisement | advertisement | region 1 |
| | | | end | end | |
| 5 | Product A2 | Text data 1 | 15 minutes | 3 hours after | Text listing |
| | | | after | advertisement | region 1 |
| | | | advertisement | end | |
| | | | end | | |
| 6 | Product A2 | Streaming | At the same | Data length | Popup window |
| | | data 1 | time as | | |
| | | | advertisement | | |
| | | | end | | |

That is, advertisers, CM contents (creative), broadcast station names which broadcast program, CM start time, and CM end time are recorded.

Subsequently, in the advertisement condition DB (122), the advertisement data and its transmission conditions are stored in advance, which is an information table as shown in Table 2 as an example.

TABLE 2
Transmission condition

| | Advertisement | Advertisement | Transmission | Transmission | Transmission |
|---|---|---|---|---|---|
| 1 | contents | data | start timing | end timing | destination |
| 2 | Product A1 | Banner data 1 | 30 seconds | 15 minutes | Banner |
| | | | after | after | listing |
| | | | advertisement | advertisement | region 1 |
| | | | end | end | |
| 3 | Product A1 | Banner data 2 | 15 minutes | 5 hours after | Banner |
| | | | after | advertisement | listing |
| | | | advertisement | end | region 2 |
| | | | end | | |
| 4 | Product A2 | Banner data 3 | 30 seconds | 15 minutes | Banner |
| | | | after | after | listing |
| | | | advertisement | advertisement | region 1 |
| | | | end | end | |
| 5 | Product A2 | Text data 1 | 15 minutes | 3 hours after | Text listing |
| | | | after | advertisement | region 1 |
| | | | advertisement | end | |
| | | | end | | |
| 6 | Product A2 | Streaming | At the same | Data length | Popup window |
| | | data 1 | time as | | |
| | | | advertisement | | |
| | | | end | | |

The contents in Table 2 will be described in detail. In the transmission condition, the CM contents, advertisement data, transmission start timing of the advertisement, the end timing of the same, and the transmission destination of the advertisement on the web page (site) are defined. FIG. 13 shows an example of a screen display (90) displayed using a web browser in the user terminal device.

For example, with regard to the product A1 on the second row, it is defined that the banner data 1 accumulated in the advertisement condition DB is displayed in the banner listing region 1 (900) on the site from 30 seconds after the CM ends to 15 minutes after. Combined with the information in Table 1, the data of the banner data 1 is displayed from 15:01:00 to 15:15:30 on Mondays.

Then, according to the transmission condition on the third row, the banner data 2 is displayed in the banner listing region 2 (901) from 15 minutes after the advertisement ends to 5 hours after. An advertising rate on the Internet web page is determined by display position, display size, display time, display frequency and the like in general, and the banner listing region 1 with the highest advertisement effectiveness is used immediately after the CM ends and then, the display is made in the banner listing region 2 for 5 hours. By defining the transmission condition as above, the advertisement mode on the web page can be changed in a complicated manner in collaboration with delivery of the CM.

Also, in the transmission condition on the fifth row, it is defined that the text advertisement for the product A2 is placed in the text listing region 1 (902). In the transmission condition on the sixth row, it is defined that video by the streaming data 1 is displayed on the popup window (new exclusive window is opened) (903). In this way, advertisement data in various data formats can be freely defined for the transmission conditions of the present invention.

The advertisement data itself does not have to be stored in the advertisement condition DB (122) but it may be so configured that the image files, video files, text files, sound files and the like are stored separately, and file names, directory names and the like indicating the storage locations are stored instead. Also, it may be so configured that the advertisement data itself is stored in another server device on the network such as a server device of the advertiser, for example, and its URL is stored as information of the advertisement data.

Together with the advertisement information and the transmission conditions as above, if the transmission condition is satisfied by the clocking result at the clocking portion (101), the display-mode parameter setting portion (107) sets a display mode parameter according to the listing condition DB (123) in the present invention.

The listing advertisement will be explained. As shown in FIG. 13, the display mode, that is, the display position, display rank, character format, the number of seconds, frequency and the like in each advertisement region are varied depending on the advertising rate. The display positions are given priority ranks according to a degree of conspicuousness, ease to be clicked by users, a degree of recognition rate of the banner and the like as the banner listing region 1 and the banner listing region 2, and it is determined that single display of the region 1 costs 30 yen, and the region 2 at 20 yen, for example.

The banner advertisement is often charged per click (one of actions, which will be described later) by a user instead of the display frequency. In the following explanation, the advertising rates on display include a case requiring user's actions.

In this embodiment, as shown in Table 2, in which banner listing region the display is to be made is defined in the transmission condition, but it may be so configured that the transmission condition defines only whether or not the display is to be made in any of the banner listing regions in the site and the display mode parameter defines which banner listing region is to be used for the display.

The display rank is a rank of listing in the text listing region 1. That is, if plural advertisement data is displayed in the same region, since the advertisement effectiveness is different depending on the display rank, the advertisement of an advertiser who paid the highest advertising rate is displayed on the first rank followed by the second. As is well known, the advertisers are invited to bid for the display rank at present in competition for the advertising rates.

The character format is a display mode such as the character size, character color, background color, italic, bold and the like in the text display. It is defined such as an advertising rate for bold, advertising rate for red and the like.

The number of seconds refers to the number of seconds during which a banner or a video is displayed, and naturally, the larger the number of seconds, the higher the advertising rate is set. The frequency is a frequency that a banner is displayed and includes various concepts on the frequency such that single display is made for three accesses at a user terminal of a specific user in the banner listing region 1, the number of transmission times from the device should be 10000 impressions for all the users in one week and the like. That is, the display mode determined by time and the number of times is called the frequency, and a target may be either an individual frequency by identification of a user terminal (which can be reduced into practice easily by using cookie) or the entire frequency.

Conditions determined in balance with an advertiser's budget, advertisement effectiveness regarding the above display modes and the advertising rates are the listing conditions in the present invention. An example of the listing condition DB (123) is shown in Table 3.

TABLE 3
Listing condition

| | Advertisement | | | Advertising |
|---|---|---|---|---|
| 1 | contents | Region | Display mode | rate |
| 2 | Product A1 | Banner | 10000 | Upper limit |
| | | listing | impressions | of 50 |
| | | region 1 | in one week | thousand yen |
| 3 | Product A1 | Text listing | Within top | Within 39 yen |
| | | region 1 | three | for one click |

If CM of the product A1 is broadcast and the transmission condition is satisfied (S10), the display-mode parameter setting portion (107) sets the defined display mode/advertising rate for each region. Specific explanation will be given according to Table 3. It is set for the banner listing region 1 that 10000 impressions in one week are transmitted within the advertising rate of 50 thousand yen. At this time, since the advertising rate for the banner listing region 1 is defined by a provider of a site (a search site, for example) in advance or by a competition with other advertisers, transmission of the advertisement is not necessarily guaranteed.

Also, in the configuration of pay per click by a user, too, by synchronizing CM with time when a listing advertisement is displayed, click by users who take interest upon watching the CM or increase recognition can be promoted, while the listing advertisement can be set not to be displayed in a time zone with many users with low recognition.

It is known that such listing conditions are set on a management site of the listing advertisement in general, and there is such a case that by setting upper limit rate, automatic competition with other companies leads to an advertisement displayed within a set rate. However, the present invention is characterized by combination with the transmission condition, and instead of placing a listing advertisement under the same condition all the time, the advertisement can be placed at timing when the highest effect can be obtained in synchronization with CM in the broadcast.

As described above, if a display mode parameter is set (S11), the advertisement transmission portion (105) transmits an advertisement according to the parameter (S12). As shown in the condition on the third row in Table 3, if a link to the homepage is arranged in the text listing region 1 and a unit price for a click by a user on the link is set within 39 yen, and if the link cannot be called with 39 yen within the top three rank, the listing condition is not satisfied, and the advertisement is not transmitted even if the transmission condition is satisfied. This is realized naturally since the display-mode parameter setting portion (107) sets the display mode parameter only in a range set by the advertiser in each region, by which placement of an advertisement from which the advertiser cannot obtain proper cost effectiveness is prevented.

The advertisement data transmitted from the advertisement transmission portion (105) when the advertisement transmission portion (105) transmits the advertisement data to the user terminal device is transmitted from the network adapter (110) to the user terminal device under control of the communication portion (104). The advertisement data is outputted from the screen, a speaker and the like of the terminal.

In the above transmission conditions, the condition is shown as an example that transmission is made immediately after the end time of the CM or after a certain period of time has elapsed with the end time as a reference, but before or after the CM or the length of the time zone is arbitrary. For example, by increasing exposure of the advertisement on the Internet from 30 minutes before the CM and by giving the CM by each TV station when the interest of users making accesses is heightened, recognition by the users can be made certain.

Moreover, supposing that the broadcast media is broadcast on the Internet and the delivery period of the program is from Oct. 1 to Oct. 14, 2006. Then, the transmission conditions for a longer period may be defined such that the advertisement data is synchronized with that and the banner advertisement is displayed in the banner advertisement region 1 (900) at the transmission start timing from Oct. 1 to 14, 2006 and then, the banner advertisement is displayed in the banner advertisement region 2 (901) from October 15 to 22.

There has been a case in which the advertisement by broadcast media such as TV and the advertisement on the network are placed manually at the same timing. According to the present invention, while transmission of the advertisement is automatically grasped by the advertisement information DB (121), appropriate advertisement data can be transmitted at appropriate timing according to complicated conditions defined by the transmission conditions. As a result, when users who took interest through the broadcast media access the Internet, the advertisement is displayed at a position with high visibility, and high advertisement effectiveness can be obtained. Moreover, by changing the advertisement position with time, the screen mode can bring about changes, and contribution can be made to reduction of advertising costs.

### Second Embodiment

Regarding the listing condition setting (S11), the present invention is provided with an advertisement effectiveness determination portion (109), and a listing condition setting portion, not shown, in the CPU (100) sets the listing condition DB (123) according to its determination result. FIG. 4 shows a flowchart of this processing. The advertisement effectiveness determination portion (109) calculates a degree of advertisement effectiveness by CM on the basis of the advertisement information DB (121).

The following two effectiveness calculation modules are used for the calculation here. Each module is implemented in the advertisement effectiveness determination portion (109). One of them is a direct effectiveness calculation module, and inputted parameters include timing, day, time zone, broadcast station, audience rate, program genre, region and the like of the CM. It is information such as “October, beginning of the month, Friday, 5 pm, Fuji TV, news program, audience rate of 10%, Tokyo”, for example. The audience rate among them can be estimated from day, time zone and broadcast station by preparing past achieved audience rate data.

The direct effectiveness calculation module calculates a direct effect of the CM according to parameters when the CM is transmitted. A value indicating an effect is given to each parameter such that 0.6 to 5 pm and 0.7 to 6 pm for time zone and 0.5 to a news program and 0.8 to a variety program for program genre, for example, and after the parameters are given appropriate weighting, a direct effect value is obtained by a calculation equation to obtain the total value. For example, supposing that the weight of the audience rate is 10 and the other weights are 1, the direct effect value of a news program with the audience rate of 5% at 5 pm is 0.05×10×0.6×0.5=0.15, the direct effect value of a variety program with the audience rate of 10% at 6 pm is 0.10×10×0.7×0.8=0.56, and the direct effect value when the CM is given in the both programs is calculated as 0.71.

The other is a contact effectiveness calculation module, and inputted parameters include the accumulated number of past advertisements, GRP (which will be described later), advertisement reach (which will be described later), advertisement frequency (which will be described later), the respective periods and the like. For example, such a calculation can be made that “possibility of contact with the same advertisement five times in the past one month is 60%” from these parameters. The calculation method will be described below in detail. And the contact effect value can be determined from a correspondence table set in advance such that the possibility of 5-time contact of 60% is 0.8 and that of 80% is 0.9. The explanation will be made below supposing that the contact effect value is 0.8.

The advertisement effectiveness determination portion (109) can calculate a value of the effect of the CM by totaling calculated values from the both modules, for example. In the above example, the value can be acquired as 0.71+0.8=1.51. In the present invention, the above parameters are preferably used, but its specific calculation method can be set as appropriate, and the above is only an example for explanation easily to be understood. In any case, by defining types of parameters and values according to the items and by substituting the values in a predetermined calculation equation, the advertisement effectiveness value can be obtained.

Then, the advertisement effectiveness is determined (S20). The determination may be made such that a predetermined threshold value is set and if an advertisement effectiveness value exceeds the threshold value, the advertisement has effectiveness, while if the threshold value is not exceeded, the advertisement does not have effectiveness, or the advertisement effectiveness value may be the determination result.

The listing condition setting portion changes the condition so that the listing condition is relaxed when the advertisement effectiveness is heightened, for example (S21). That is, CM needs several advertisement reach till recognition even if the CM is broadcast, and the recognition degree is disposed to be heightened gradually with placement of the CM as will be described later. Then, a direct effectiveness value is added to such a contact effectiveness value so as to relax the listing condition, by which the advertisement effectiveness can be improved and an advertising cost can be suppressed.

Specifically, at a stage determined to have advertisement effectiveness, the display rank of “within top three” is changed to “first rank” in the listing condition, the rate of “39 yen” for 1 click is changed to “51 yen” or the upper limit value on the rate is deleted in the listing conditions, for example. Of course, in the present invention, supposing that at the stage with heightened recognition, active access from users can be expected, the display rank may be changed from “first rank” to “within top three” to the contrary, and the configuration can be designed appropriately according to targeted advertisement effectiveness level.

The conditions after such a change if advertisement effectiveness can be expected may be stored in the hard disk in advance both for the conditions before and after or it may be so configured that the display mode after the change can be calculated based on a predetermined calculation equation. For example, it may be so configured that the rate for 1 click is changed to an amount (45 yen) corresponding to 30 times of the advertisement effectiveness value (1.51). Alternatively, in a goods sales site, it may be so configured that a database of goods to be sold is referred to, and the rate is defined at 0.5% of the goods price sold in the advertisement.

### Third Embodiment

FIG. 5 shows a configuration in which the listing condition is varied if a user reacts to a listing advertisement and takes some action. That is described as a third embodiment. First, a user action acquisition portion (108) is provided in the CPU (100), and a user's reaction to the listing advertisement is acquired as data.

That is, as shown in FIG. 14, if the device (10) is a search site server device, suppose that a banner advertisement (911) of a car B, which is a new product of an A company, is displayed in the banner listing region 1. This banner advertisement is also displayed according to the transmission conditions and a listing condition as mentioned above. And if a user who viewed the CM accesses the search site (910) sees the banner advertisement and clicks it, for example, it is linked with a page (920) of the car B on a homepage of the A company as known.

Such a clicking action on a banner is one of user actions, and it is proposed in the present invention that the listing condition DB (123) is set according to this user action. First, processing of the user action acquisition portion (108) is described. A code to transmit a specific character string is added to the user action acquisition portion (108) of this server as a link of the banner advertisement, for example, so that the information is transmitted to the user action acquisition portion every time the user clicks the banner. That is, by specifying http://kensaku.dentsu.co.jp/search?p=(search word)&link?p=(link) as a link, (search word) can be notified to kensaku.dentsu.co.jp (this is made as an address of the user action acquisition portion) and at the same time, it is only necessary that a connection destination of the web browser is changed to the (link). Such a method is a known matter.

Moreover, the user action acquisition portion (108) may obtain information on what word is searched in the search site or information after having moved to the homepage of the advertiser (whether or not the product is purchased, a material is requested, viewed for 10 minutes, stopped watching immediately after that and the like). These can be obtained directly by the device through a known method or from the information from the connected server device.

After the user action acquisition step (S30), the advertisement effectiveness determination portion (109) determines advertisement effectiveness. In addition to the configuration described in the second embodiment, advertisement data and a display mode of the listing advertisement are inputted, and the advertisement effectiveness is determined (S31) from a relationship between the user action and the listing advertisement.

In a simple example, if a listing advertising rate is given, a unit price per advertisement is acquired from the advertising rate spent on a listing advertisement and the number of accesses to the link, and if the amount is smaller than a predetermined value, it means that the advertisement efficiency is poor, and the listing condition is changed (S32). Such regulations may be defined in advance or defined using a predetermined calculation equation as described above.

In order to acquire a user action accurately, it is preferable that individual user terminals are identified using known cookie so as to obtain information from each terminal. The acquisition of the user action in the present invention is not necessarily limited to the information that “an action was taken” but information that “an action was not taken” may be obtained, and it may be so configured, for example, that the banner advertisement is displayed in the listing banner region 1 for the first five times but if there is no action to access the link during that period, it is determined that the advertisement effectiveness is small and a change is made so that the listing condition is not displayed (by setting the advertising rate extremely low, for example).

Also, not only a user's action to the listing advertisement but a behavior history of the user in the search site may be obtained and used for setting of the listing conditions. For example, if facts that a search for a keyword relating to a car is made repeatedly on the search site or a video delivery of a car is viewed are recorded in user behavior history information (not shown) in the hard disk, the user action acquisition portion (108) reads them out, and if the user has an interest in the same field as the CM, the advertisement effectiveness determination portion (109) determines that the advertisement effectiveness is particularly high, and the listing condition setting portion makes setting so that the rank of the listing advertisement comes to a high rank (S32).

In the present invention, the listing condition can be set as appropriate by the configuration of the second and third embodiments. By changing the condition according to advertisement effectiveness, more optimal listing advertisement can be transmitted in addition to the effect of the first embodiment.

### Fourth Embodiment

The setting of the listing condition according to the present invention is described above. Some embodiments of the transmission condition will be described. As a fourth embodiment, a configuration in which the CPU (100) shown in FIG. 2 is provided with an advertisement frequency estimation portion (102) and its estimation result is used for determination of the transmission condition will be described.

First, the advertisement frequency will be described using FIG. 9. In advertising agencies, the advertisement frequency (frequency) is used as a parameter for measuring effectiveness of the advertisement. The advertisements may be intended for the public receiving the broadcast or may be intended for specific targets such as apart of the public, age, sex, occupation, position in the household (father, grandmother, children, grand-children and the like), social status and the like. An index indicating how many times the advertisement contents (creative) reach the entire public or a part thereof is the frequency.

The frequency can be searched using various methods, and an average frequency can be known by conducting a questionnaire such that “How many times have you seen the CM of the car B by the A company?” in an audience research. In the present invention, such research results may be stored in the hard disk (120) and used as they are.

However, a configuration in which the advertisement frequency estimation portion (102) executes and processes an advertisement frequency estimation step (S40) according to a processing flowchart shown in FIG. 6 will be described here. At the advertisement frequency estimation step (S40), information on the number of broadcasting times or broadcast time in the advertisement information DB (121) and the information on the audience rate researched separately are used. For example, as shown in FIG. 12, supposing that a man in the thirties does not view a program at 10 o'clock on Friday but views one at 11 o'clock and 12 o'clock, and the number of CM placement times of the car B by the A company is 0 times at 10 o'clock and 11 o'clock on Friday and 1 time at 12 o'clock, it means that the man views the CM once on Friday. By calculating similarly, the frequency of the CM by this man in this week results in 7.

Here, the example of a man belonging to a specific audience for a single channel in a limited time zone was exemplified, but since data according to specific audiences on information of the audience rates is offered by survey companies, the audience rate of a man in the thirties for a specific channel by time zone, for example, can be obtained. For example, if the audience rate of the man in the thirties at 12 o'clock on Friday is 3%, the frequency to the audiences is 1 and a proportion of the audiences is 3%, and then, the average frequency can be calculated as 0.03. The advertisement frequency estimation portion (102) can calculate the frequency of the CM for the car B by conducting the calculation processing on the basis of the advertisement information DB.

Regarding the meaning of the frequency, the following is known. That is, audiences do not fully recognize an advertisement if they have contact with the advertisement only once and an advertisement effect expected by the advertiser cannot be obtained. Herbert E. Krugman's Three-Hit Theory as a distinguished study is known, which says that the following reactions are found regarding repetition effect of an advertisement. First contact with advertisement->reaction as what it is, second contact with the advertisement->reaction as what is told about that, third contact with the advertisement->reaction to recall, fourth contact and after with the advertisement->repetition of the third reaction. That is, audiences are said to recognize the advertisement contents through at least three times of contact with the advertisement. However, since the number of three times is changed by various factors, that is a value which should be set appropriately depending on advertisement.

Particularly, it is known that the number of recognition times by contact with an advertisement is changed by the audiences, CM targeted products, types of campaign and the like, and a recognition times can be derived by means of calculation with a predetermined method based on a recognition times database defined separately in accordance with the audience, product, type of campaign and research results. In this device (10), such calculation processing can be executed. The effective contact with the advertisement as above can be confirmed by the frequency.

The higher frequency is not necessarily the better, and there can be a required minimum effective frequency (minimum effective frequency) for recognition and an effective frequency (maximum effective frequency) as an upper limit that will not tire the audience. These numbers of times can be defined in general such that the minimum effective frequency is 4 and the maximum effective frequency is 13, for example. Also, they might be determined manually on the basis of the research results on recognition rates and loss of interest in the CM conducted by a research company.

Calculations can be made on the basis of predetermined research results by various known calculation methods by the above minimum/maximum effective frequencies. The device (10) is provided with such a calculation processing function so that set values of effective frequencies can be changed for advertisement information of the processing target according to the audience, CM targeted product and the type of campaign.

In this embodiment, description is made using the relation between the frequency and the recognition number of times of advertisement, but various indexes for advertisement audiences can be used in addition to the recognition number of times. For example, the number of times till the contents (message) of the CM is understood or the number of times till an intension to purchase the product introduced in the CM is generated can be grasped in the relation with the frequency. These two indexes both have values larger than that of the recognition number of times but may be used in combination in the following transmission conditions such that all the plurality of indexes are satisfied or any of them is satisfied.

In the present invention, as the transmission conditions of the advertisement condition DB (122), conditions as in Table 4 can be added to the conditions in the first embodiment.

TABLE 4
Transmission conditions [frequency condition added]

| | | | | Transmission |
|---|---|---|---|---|
| 1 | Ad contents | Ad data | Ad frequency | position |
| 2 | Product A1 | Streaming | 0 to 4 | Popup window |
| | | data 1 | | |
| 3 | Product A1 | Banner data 1 | 5 to 13 | Banner ad |
| | | | | region 1 |
| 4 | Product A1 | None | 14 or more | (transmission |
| | | (transmission | | stopped) |
| | | stopped) | | |

According to Table 4, during time when recognition of the advertisement is important till the advertisement frequency reaches 4, the advertisement with the highest effectiveness is transmitted using a popup window, and with the frequency of 5 to 13 within the effective frequency, a banner advertisement is transmitted to the banner advertisement region 1. However, if the frequency exceeds 14, the advertisement contents have been already fully recognized by audiences, and further advertisement might have the opposite effect, and thus, the transmission is stopped.

The subsequent processing is similar to that of the first embodiment as shown in FIG. 6, in which the advertisement transmission portion (105) determines satisfaction of the transmission conditions (S41) and reads out the advertisement-amount information (S42) and then, executes the advertisement transmission step (S43). By incorporating the frequency in the transmission condition, the advertisement effectiveness can be further improved.

### Fifth Embodiment

In addition to the advertisement frequency described in the fourth embodiment, a parameter called advertisement reach can be added to the transmission condition. As a fifth embodiment, a configuration in which the CPU (100) shown in FIG. 2 is provided with an advertisement reach estimation portion (103) and its estimation result is used for determination of the transmission condition will be described.

The advertisement reach will be described using FIG. 10. In advertising agencies, advertisement reach (reach) is used as a parameter for measuring advertisement effectiveness. A proportion of people in contact with the advertisement contents (creative) in the people of the entire public or a part thereof is the reach.

The reach can be also researched by various methods, and an average reach can be known by conducting a questionnaire such that “Have you ever seen the CM of the car B by the A company?” in an audience research. In the present invention, such research results may also be stored in the hard disk (120) and used as they are.

Here, a configuration in which the advertisement reach estimation portion (103) executes and processes an advertisement reach estimation step (S51) after the above-mentioned advertisement frequency estimation step (S50) according to a processing flowchart shown in FIG. 7 will be described. The order of the advertisement frequency estimation step (S50) and the advertisement reach estimation step (S51) is arbitrary or may be simultaneous. In the advertisement reach estimation step (S51), information on the number of broadcast times and broadcast time in the advertisement information DB (121) and information on the audience rate separately researched are used.

As shown in FIG. 10, supposing that an audience rate of a part of an audience of the public (a man in the thirties) is 0% at 10 o'clock on Friday, 1% at 11 o'clock, and 3% at 12 o'clock, and the number of CM transmission times of the car B by the A company is 0 times, 0 times, and 1 time, it means that the reach at 12 o'clock on Friday is 3%.

Also, by multiplying the audience rate for each time zone by the CM transmission number of times and integrating them, the total reach can be calculated. The total reach is an index frequently used as indication of reach and represented by GRP (Gross Rating Point). Referring to the portion shown in FIG. 10 (Equation 1), 0%×0 times+1%×0 times+3%×1 time+3%×0 times+4%×1 time+5%×2 times+5%×2 times+5%×2 times+6%×2 times=49 GRP.

The advertisement reach estimation portion (103) of the present invention executes processing for calculating the advertisement reach by the above calculation. Here, as an embodiment of the present invention, the transmission conditions may be defined on the basis only of the advertisement reach. For example, the advertisement is defined to be transmitted when the advertisement reach is 5% or more so that the banner advertisement is displayed when many people come into contact with the advertisement. Alternatively, by using the total reach, it may be defined such that the advertisement is transmitted when GRP exceeds 1800.

In this embodiment, from the frequency by the advertisement frequency estimation step (S50) and the reach by the advertisement reach estimation step (S51), the reach distribution per frequency can be also obtained.

### Sixth Embodiment

In the fifth embodiment, the configuration using the frequency and the reach in combination or the configuration using only the reach is described. According to the combination of the former, the reach distribution per frequency can be obtained, and a method using the distribution as a transmission condition will be described later. Prior to that, a method of obtaining the reach distribution per frequency only by an action of the advertisement reach estimation portion (103) will be described in detail.

In this embodiment, as shown in FIG. 8, first, the CM broadcasting number of times/broadcast time and data of the audience rate in that time are inputted in the advertisement reach estimation portion (103) so as to obtain the reach distribution per frequency (advertisement reach estimation step: S60). A specific calculation method will be described using FIG. 11. First, using a man as a sample, probability that the man views the CM in a time zone A and a time zone B is acquired. This information can be obtained since presence of viewing in each time zone and each channel is contained by the unit of individuals in the audience rate data (it is well known that such audience rate data is distributed).

For example, if a man views the CM at 10 o'clock (time zone A) on Monday in the first week and does not view it in the same time zone in the second week, its probability is 50%. Similarly, if the man views it at 11 o'clock (time zone B) once in five weeks, the audience rate is 20%. The audience rate, here, is described as a probability of actually viewing the CM, but the media contact rate (probability of contact with media) and the advertisement attention rate (probability to actually pay attention to the advertisement in the people who had contact with the media) might be distinguished in general, and the audience rate may be a media contact rate or a probability (advertisement reach) obtained by multiplying the media contact rate by the advertisement attention rate.

For simplification of the explanation, only two time zones for a specific channel of a single sample will be explained, here, but actually, they all become plural parameters and a large amount of calculation processing is required. A unit of a time zone with a certain channel is called a unit in general, and the time zone A is called a unit A and the time zone B as a unit B, here.

First, the reach per unit is calculated (Step S60-1, S60-2). At this time, supposing that the CM is broadcast twice in the time zone A (800) and three times in the time zone B (801), the number of times that the CM reaches the man and its probability at that time can be calculated according to a known probability distribution model. As the probability distribution model, binominal distribution, Poisson distribution, normal distribution and the like are often used.

For example, if probabilities are distributed according to the binominal distribution, they can be calculated as follows, respectively. A probability P(r) based on the binominal distribution is expressed by an equation 2.

P(r)=ₙCᵣp^{r}(1−p)^{n-r} (Equation 2)

Here, the audience rate in the unit A is 0.5, and the audience rate in the unit B is 0.2, and then, p=0.5 and p=0.2, respectively. Also, since the CM is broadcast twice in the unit A and three times in the unit B, they are n=2 and n=3, respectively.

Then, for the unit A,

0-times reach probability is ₂C₀×0.5⁰×(1−0.5)²=0.25;

1-time reach probability is ₂C₁×0.5¹×(1−0.5)¹=0.50; and

2-times reach probability is ₂C₂×0.5²×(1−0.5)⁰=0.25.

For the Unit B,

0-times reach probability is ₃C₀×0.2⁰×(1−0.2)³=0.512;

1-time reach probability is ₃C₁×0.2¹×(1−0.2)²=0.384;

2-times reach probability is ₃C₂×0.2²×(1−0.2)¹=0.096; an

3-times reach probability is ₃C₃×0.2³×(1−0.2)⁰=0.008.

Graphs illustrating the distribution of each frequency of each unit are graphs (802) (803) in FIG. 11. In order to combine the reach of each unit, by totaling the frequencies in each unit, the result is as shown in the following Table 5. The table indicates that if the reach is once in A and twice in B, the total is three times.

TABLE 5

B

| | Frequency | 0 | 1 | 2 | 3 |
|---|---|---|---|---|---|
| A | 0 | 0 | 1 | 2 | 3 |
| | 1 | 1 | 2 | 3 | 4 |
| | 2 | 2 | 3 | 4 | 5 |

If the distribution of the probabilities corresponding to Table 5 is acquired, the probability of 0 times in A is, for example, 0.25 from the above calculation and the probability of 0 times in B is 0.512, and then, 0.25×0.512=0.128. If all the calculations are carried out similarly, the distribution is as shown in Table 6.

TABLE 6

B

| | Frequency | 0 | 1 | 2 | 3 |
|---|---|---|---|---|---|
| A | 0 | 0.128 | 0.096 | 0.024 | 0.002 |
| | 1 | 0.256 | 0.192 | 0.048 | 0.004 |
| | 2 | 0.128 | 0.096 | 0.024 | 0.002 |

From the above table, the probability that the CM reaches the man 0 times is as 0.128, and the probability of reach once can be calculated as 0.096+0.256=0.352, which results in Table 7.

TABLE 7

| Advertisement frequency | Advertisement reach |
|---|---|
| 0 | 0.128 |
| 1 | 0.352 |
| 2 | 0.344 |
| 3 | 0.146 |
| 4 | 0.028 |
| 5 | 0.002 |

This is a step (S60-3) to obtain the advertisement reach distribution to a certain person by combining the reaches of plural units as above. Actually, by carrying out the above for a large number of sample people and taking an average value, the distributions of the advertisement frequency and advertisement reach in a certain period can be obtained.

For example, the β binominal distribution model by Metheringham can be used as a more sophisticated method. This model is widely used in order to obtain the frequency distribution and is known to be able to obtain accurate values with fewer parameters (See Non-Patent Document 2). Other than that, as the method for obtaining probability distribution in the present invention, known suitable techniques can be used as appropriate.

Non-Patent Document 2: Shigeru Kido, “Advertisement Management”, pp. 28 to 54, Asakura Shoten, May 15, 2004

A graph (804) of the distribution in Table 6 is shown in FIG. 11. Samples may be selected at random in order to express the entire public or the distribution of a part of the public such as female in the thirties or male college students, for example, may be obtained.

As mentioned above, from the methods in the third embodiment or in the fourth embodiment which can calculate accurate data more suitably or from direct research, the distributions of the frequency and reach can be obtained. A graph of the same kind as that of the graph (804) in FIG. 11 and closer to the actuality is shown in FIG. 12. A part of data in FIG. 12 is shown in Table 8.

TABLE 8

| Frequency X | X-times reach | X-times or more reach |
|---|---|---|
| 1 | 4.0% | 98.0% |
| 2 | 4.5% | 94.0% |
| 3 | 5.0% | 89.5% |

By calculating the reach x-times or more as in Table 8, indexes of advertisement effectiveness more precise than the advertisement frequency in the second embodiment can be obtained such that those who saw the advertisement once or more is 98% and twice or more is 94%, for example.

In the advertisement frequency in FIG. 12, if 4 times to 11 times (a painted portion in the graph) are effective advertisement frequencies, the target the advertisement reached is the target which the advertisement contents effectively reach. The total of the advertisement reach in this number of times region is called effective advertisement reach (effective reach).

In this embodiment, the effective advertisement reach is defined as the transmission condition as in Table 9.

TABLE 9
Transmission condition (effective advertisement reach
condition added)

| | | | Effective ad | Transmission |
|---|---|---|---|---|
| 1 | Ad contents | Ad data | reach | position |
| 2 | Product A1 | Streaming | 60% or more | Popup window |
| | | data 1 | | |
| 3 | Product A1 | Banner data 1 | 30 to 60% | Banner ad |
| | | | | region 1 |
| 4 | Product A1 | Text data 1 | 30% or less | Text ad |
| | | | | region 1 |

Similarly to the first and second embodiments, if the advertisement transmission portion (105) determines that the transmission condition is satisfied (S52) (S61), the advertisement data is transmitted at the advertisement transmission step (S54) (S63).

### Seventh Embodiment

The case in which the broadcast program is the advertisement is explained in the above embodiment, but the present invention can be intended for any broadcast show such as news, information program, variety program, quiz show, sport program and the like. First, the program contents are extracted from the database of the program contents such as an electronic program table. Then, suppose that the following broadcast information database is provided, for example.

TABLE 10
Broadcast information

| Broadcast | Broadcast | Broadcast | | |
|---|---|---|---|---|
| show | contents | station | Start time | End time |
| News A | Hybrid car on | X TV | 12/1 | 12/1 |
| | the rise | | 15:00:00 | 15:30:00 |

That is, in the news A, news with the contents that the number of hybrid car registrations is on the rise is broadcast, and the time is from 15:00 to 15:30 on December 1 is recorded.

After such news is broadcast, consumers' interest in the hybrid cars is heightened, and it is preferable to transmit the advertisement immediately after that. Therefore, by providing the following transmission condition, for example, the advertisement can be transmitted.

TABLE 11
Transmission condition

| Keyword | | | | |
|---|---|---|---|---|
| contained in the | | | | |
| broadcast | | Transmission | Transmission | Transmission |
| contents | Ad data | start timing | end timing | position |
| Hybrid car | Banner | Simultaneously | 1 hour after | Banner |
| | data 1 | with broadcast | the | listing |
| | | start | broadcast | region 1 |
| | | | end | |

According to the above transmission condition, the transmission condition is determined by detecting that the keyword of the “hybrid car” is included by a known character string search technique, morphological analysis technique and the like from the broadcast contents of “hybrid car on the rise”, and the banner data 1 is transmitted to the banner advertisement region 1 simultaneously with the broadcast start.

### Eighth Embodiment

Moreover, even for the advertisements not included in the broadcast contents in the electronic program table, information on the goods relating to the goods and service can be extracted from the broadcast contents by providing an information extraction portion, not shown, in the CPU (100). That is, the information extraction portion refers to a goods information database, not shown, in the hard disk (120), determines that the information relates to a specific advertiser's goods from the broadcast contents, and can uses it as the advertisement contents of the above embodiment. For example, the following goods information database is provided.

TABLE 12
Goods information database

| Keyword contained in the | |
|---|---|
| broadcast contents | Advertisement contents |
| Car | Car A1 by A company |
| | Car inspection service B1 by B |
| | company |
| Metabolic | Salad oil C1 by C company |

If the “car” is contained in the broadcast contents, processing similar to the case in which advertisements of “car A1 by A company” and “car inspection service B1 by B company” are broadcast is executed. In this way, one broadcast may include two or more advertisement contents, or one for “metabolic” and one for “salad oil C1 by C company” may be defined, and setting can be made appropriately, giving consideration to advertisement effectiveness.

In the goods information database, the goods to be associated with the broadcast contents may be a name of a specific goods or a company name dealing with the goods. For example, instead of the salad oil C1 by the C company, it may be the mere business advertisement of the C company. Alternatively, it may be the advertisement of all the products handled by the C company.

As the broadcast program, the advertisement and the broadcast show may be both included in the configuration. That is, if the “car” is contained in the broadcast contents and the “car A1” is broadcast in the inserted CM, since the car is taken up in the program and also in the CM, viewers' interest has been increased, and transmission of the advertisement data of the car at this timing exerts synergetic effects.

Lastly, a configuration in which instead of storing the advertisement information database (121) in the hard disk (120) in advance, placement of CM is recognized on a real time basis and recorded in the advertisement information database in the present invention will be described. A case in which CM is used for the broadcast program is described in the embodiment below, but the present invention can be applied to a case in which the broadcast program is a show completely similarly. Here, a configuration diagram is shown in FIG. 15 as advertisement recognition device (20) separately from the listing advertisement transmitting device (10).

It is simple that the advertisement recognition device (20) is also embodied by a personal computer and can be configured integrally with the device (10). In the advertisement recognition device (20), a CPU (200), memory (210), a network adapter (220), a hard disk (230), and a tuner portion (240) are provided.

The CPU (200) is provided with an image recognition processing portion (201) for image pattern matching with a logo database (231) stored in the hard disk (230) using a known pattern matching technique. In the logo database (231), image data which can identify advertisement contents such as logos of company names of advertisers and goods logos is recorded. The image recognition processing portion (201) carries out pattern matching by comparing the image data on a broadcast screen obtained by the tuner portion (240) and the image data of the logo.

Here, comparison targets in the image recognition processing portion (201) are not limited to the image data of logos but may be an entire screen of a moment in CM, for example, and sample images may be stored in the hard disk (230) in advance so that pattern matching is carried out between the sample image and the image on the broadcast.

Subsequently, a sound recognition processing portion (202) is provided in the CPU (200). A known method can be also used for the sound recognition, but in the sound recognition used in the present invention, sound waveform data of sound on the broadcast is compared with sound waveform data in a sound database (232) stored in the hard disk (230) in advance, and a degree of similarity is measured. Simple methods include a method in which a data value of each sound waveform is expressed by vector array and Euclidean distance between the vector arrays is acquired.

In the sound database (232), sound data when a business name is announced or a voice of an actress performing in CM of the product can be registered, for example. A database of background music of the product may be prepared as a BGM database (233) so that sound can be recognized.

As described above, from a recognition result by the image recognition processing portion (201) and the sound recognition processing portion (203), it is determined if it is advertisement information of a target extracted in the advertisement information extraction portion (203). A reference at this time can be set in various ways, but if it is determined that matching with a high probability larger than a predetermined threshold value is obtained in either of the recognition processing, it is determined as the advertisement information. The determination as advertisement information may be made if a result of totaling the both probabilities is more than a predetermined threshold value, even though the probability is not sufficiently high in each.

The determination result is recorded in the advertisement information database (234) of the hard disk (230) together with a clocking result in the clocking portion, not shown, and channel information which can be obtained in the tuner portion (240).

In the present invention, since listing advertisement is transmitted on the basis of the advertisement information database (234), synchronization with CM broadcast real time can be realized in combination with the advertisement recognition device (20).

With regard to these methods, software for automatically extracting a logo mark of a business from TV broadcast is known and disclosed in non-patent documents or the like.

Non-Patent Document 3: ITR Corporation, “Intelligent Brand Analysis”, homepage http://www.itr.co.jp/iba/; Non-Patent Document 4: Repucom, “REPUCOM: the most accurate brand analysis information” homepage http://www.repucom.net/

The configuration of the present invention is as described above, and the device (10) is preferably incorporated in a server device of a search site in the Internet such as Yahoo! (registered trademark) or Google (registered trademark), for example. In general, many of viewers motivated to search the advertisement contents upon seeing the CM make an access to the search site. Thus, by transmitting the advertisement relating to the present invention in a banner column or the like on the search site, the advertisement can be presented to the users the most effectively.

Another merit in displaying the advertisement on the search site is that when the public who recognized the CM through mass media visits the search site, an advertisement such as a banner with associated advertisement contents is displayed and recognition or involvement with the CM or brand is increased for a longer period than the unit of minute or hour during which the CM is broadcast, that is, the unit of day, week or month. Advertisements are preferably transmitted to the public through a plurality of paths, and even viewers who do not see or recognize the CM increase the recognition of the product by the advertisement in a banner, and if the CM reaches the viewers in that state, larger advertisement effectiveness can be exerted.

Also, those who saw the CM in the banner can be surely led to the homepage of the target product. For advertisers, it is preferable that the viewers who saw the CM access their own web pages, and the banner advertisements in the search site have an important meaning.

Similarly, the device (10) can be incorporated in a server device of a goods sales site (Rakuten (registered trademark), for example) selling the goods. In this configuration, when the viewers saw the CM and started a purchasing activity, it is preferable that the viewers are directly led to the web page of the goods or a purchase page without competitors' goods which could be examined for purchase at the site or outflow to other goods, and transmission of the banner advertisements and the like has an extremely high effect from the viewpoint of advertisement effectiveness.

Other than the configuration to be incorporated in the search site server or goods sales site server, there can be a configuration in which image data or the like as the advertisement data is transmitted to regions such as predetermined banner advertisement columns, text advertisement columns and the like in each server in conjunction with these existing servers or a configuration in which the image data or the like stored in the device as a link from the regions is transmitted to a user terminal device.

### BRIEF DESCRIPTION OF THE DRAWINGS

FIG. 1 is an entire diagram of a system in which a listing advertisement transmitting device according to the present invention is installed.

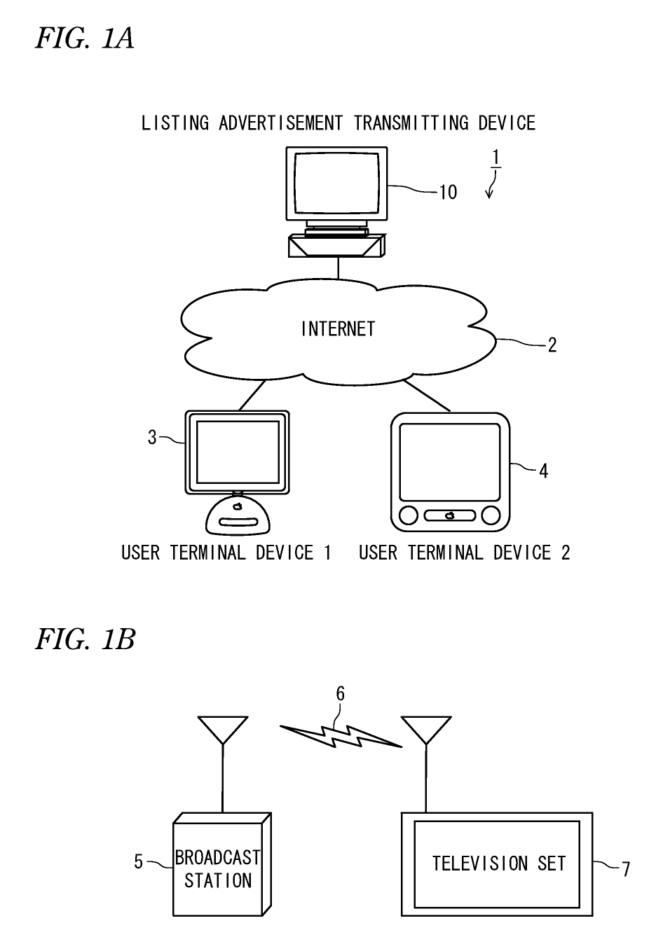

FIG. 2 is a configuration diagram of the listing advertisement transmitting device according to the present invention.

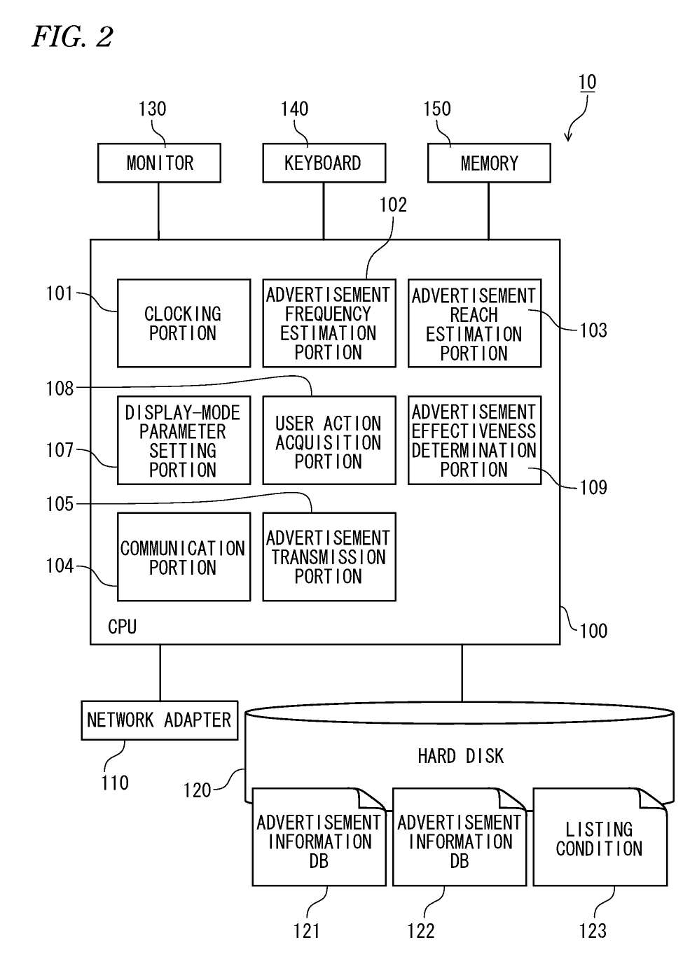

FIG. 3 is a processing flowchart (first embodiment) of a listing advertisement transmitting method according to the present invention.

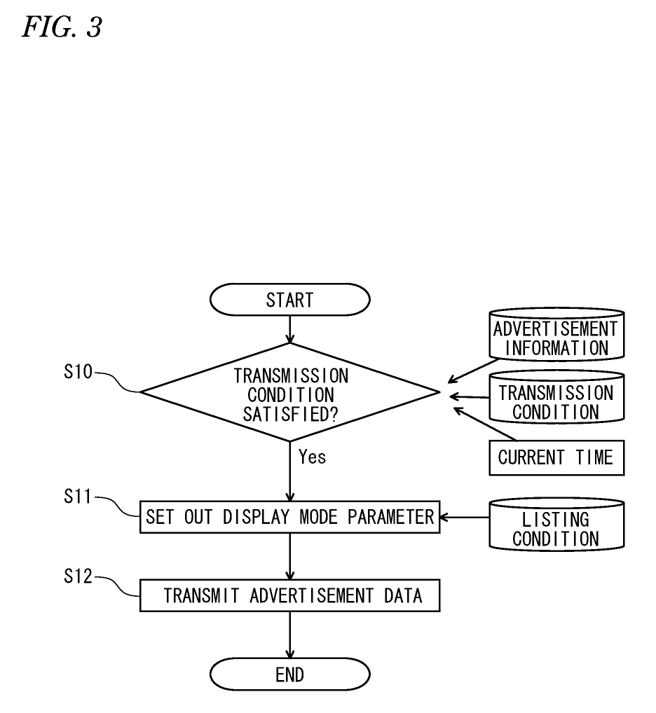

FIG. 4 is a processing flowchart (second embodiment) of listing condition setting according to the present invention.

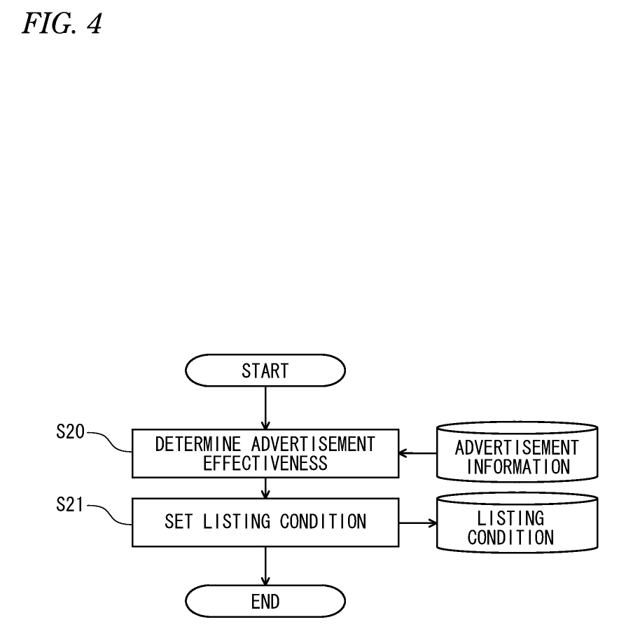

FIG. 5 is a processing flowchart (third embodiment) of listing condition setting according to the present invention.

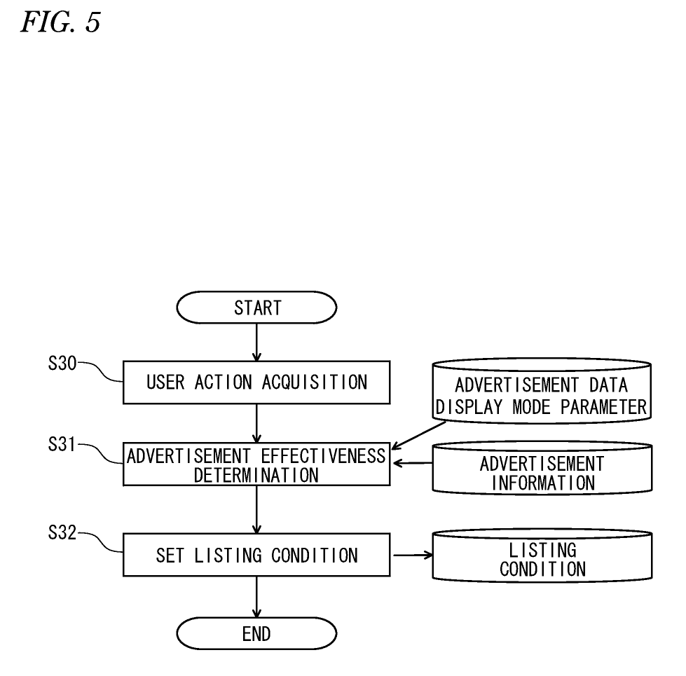

FIG. 6 is a processing flowchart (fourth embodiment) of a listing advertisement transmitting method according to the present invention.

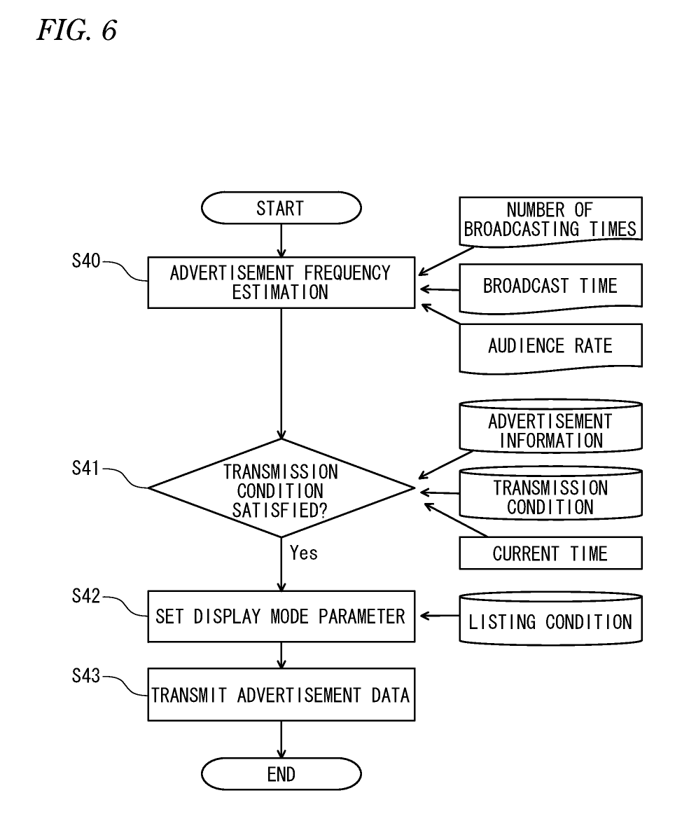

FIG. 7 is a processing flowchart (fifth embodiment) of a listing advertisement transmitting method according to the present invention.

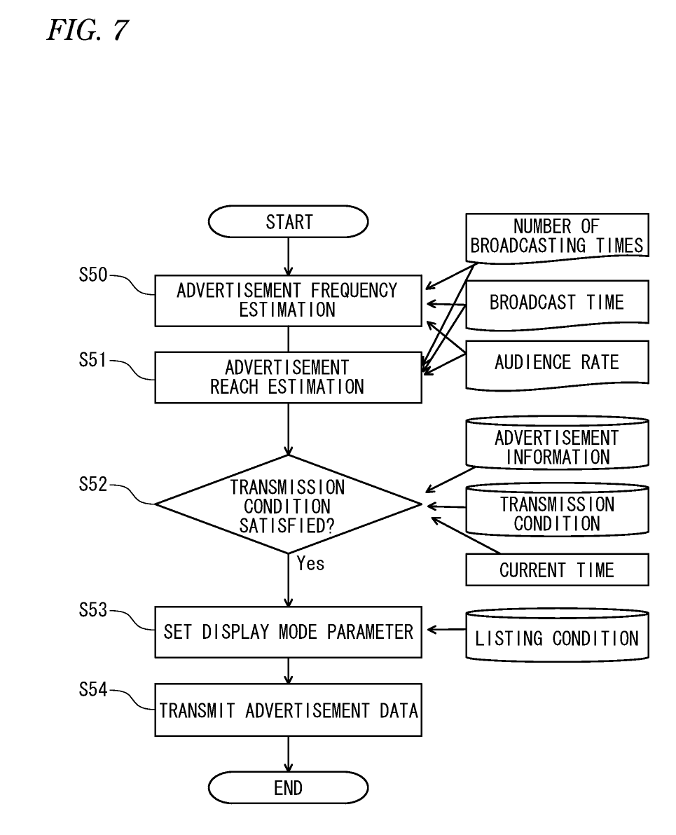

FIG. 8 is a processing flowchart (sixth embodiment) of a listing advertisement transmitting method according to the present invention.

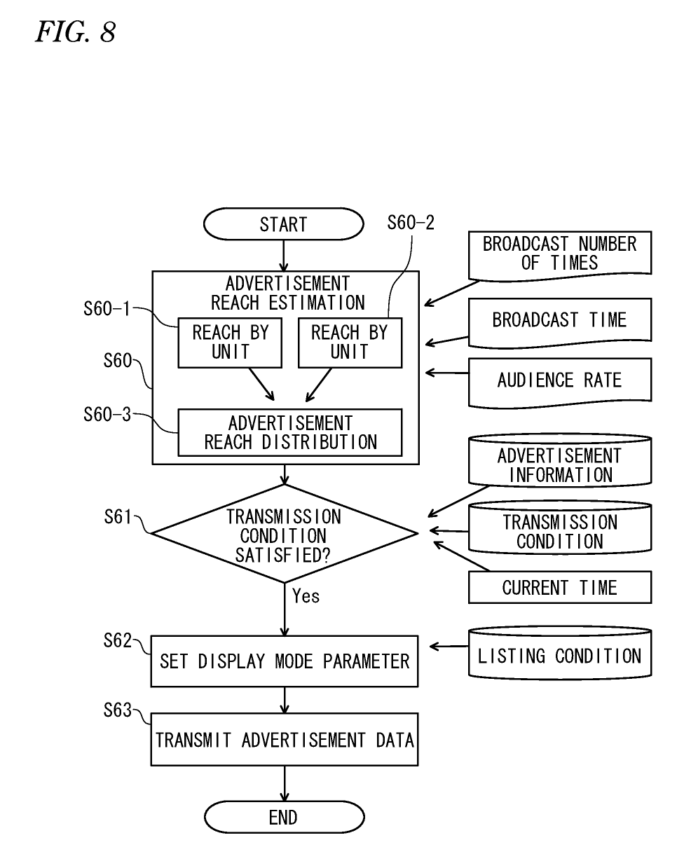

FIG. 9 is a diagram for explaining a calculation method in an advertisement frequency estimation portion.

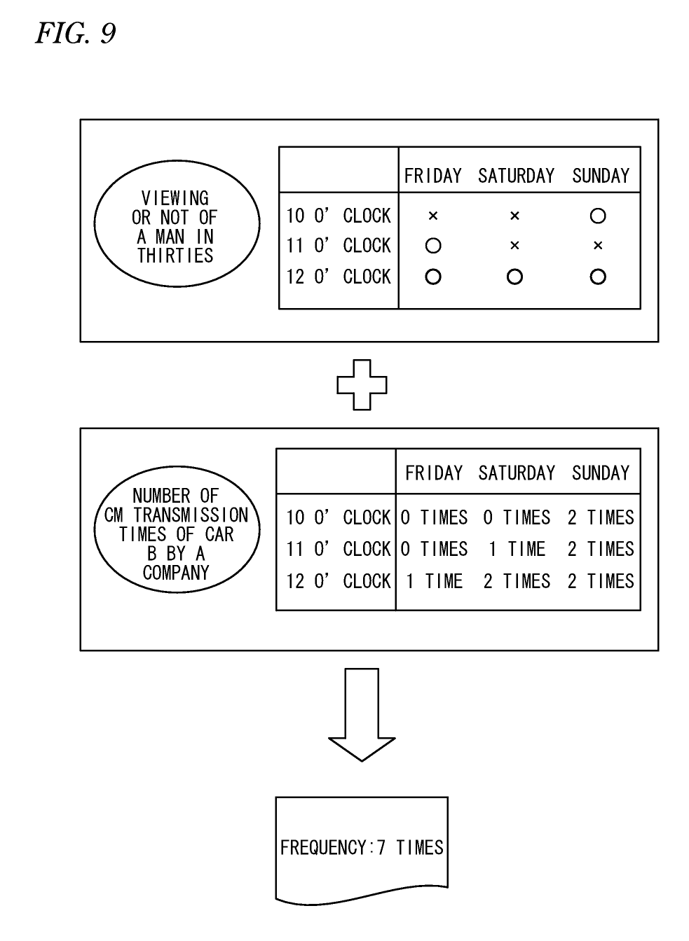

FIG. 10 is a diagram for explaining the calculation method (fifth embodiment) in the advertisement reach estimation portion.

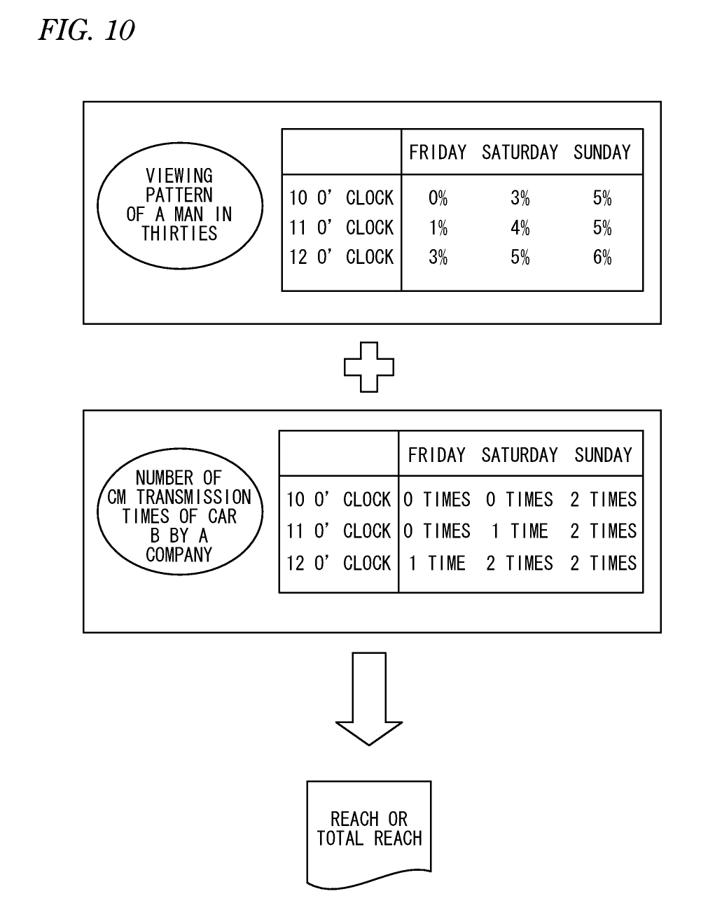

FIG. 11 is a diagram for explaining the calculation method (sixth embodiment) in the advertisement reach estimation portion.

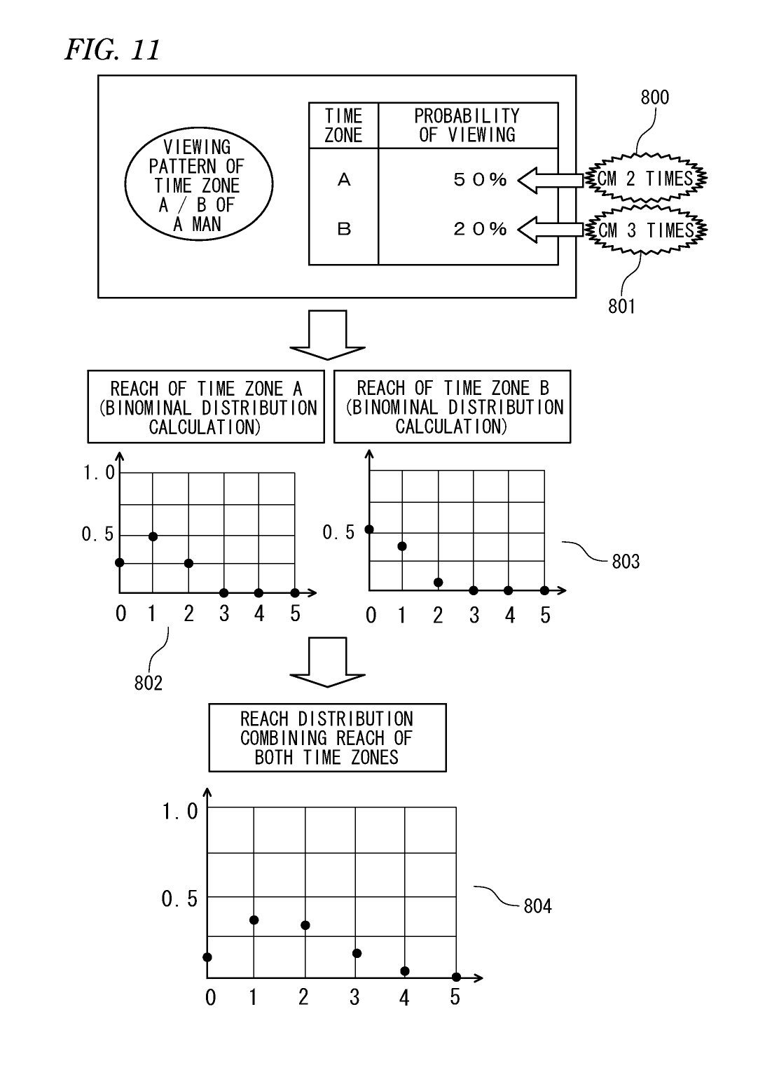

FIG. 12 is a graph illustrating effective advertisement frequency distribution.

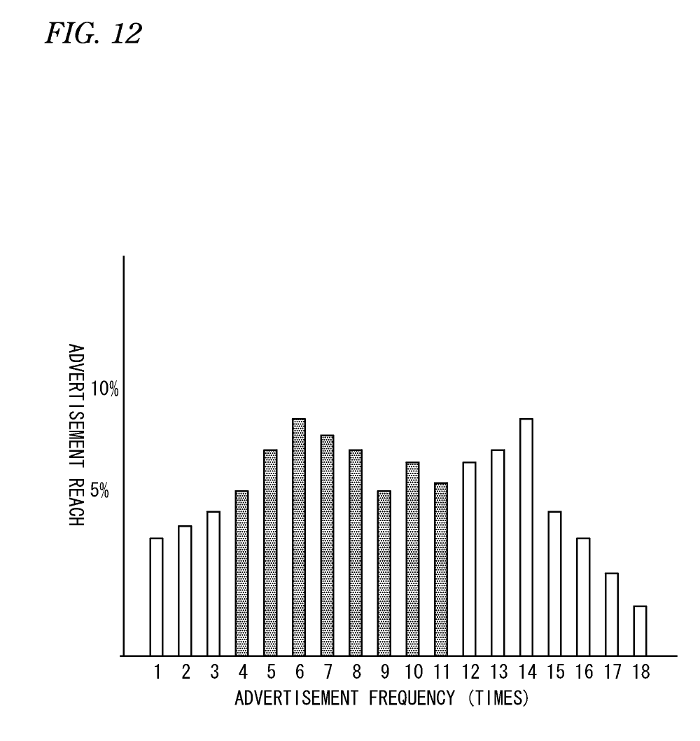

FIG. 13 is an image of a screen for explaining a position of an advertisement display.

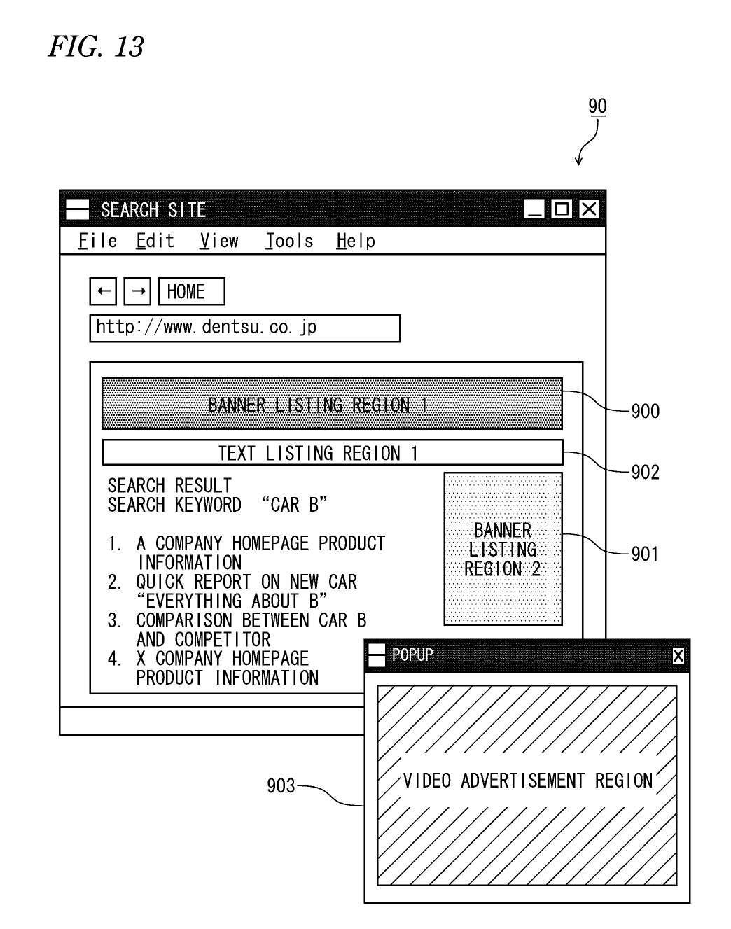

FIG. 14 is an image of a screen for explaining a user action.

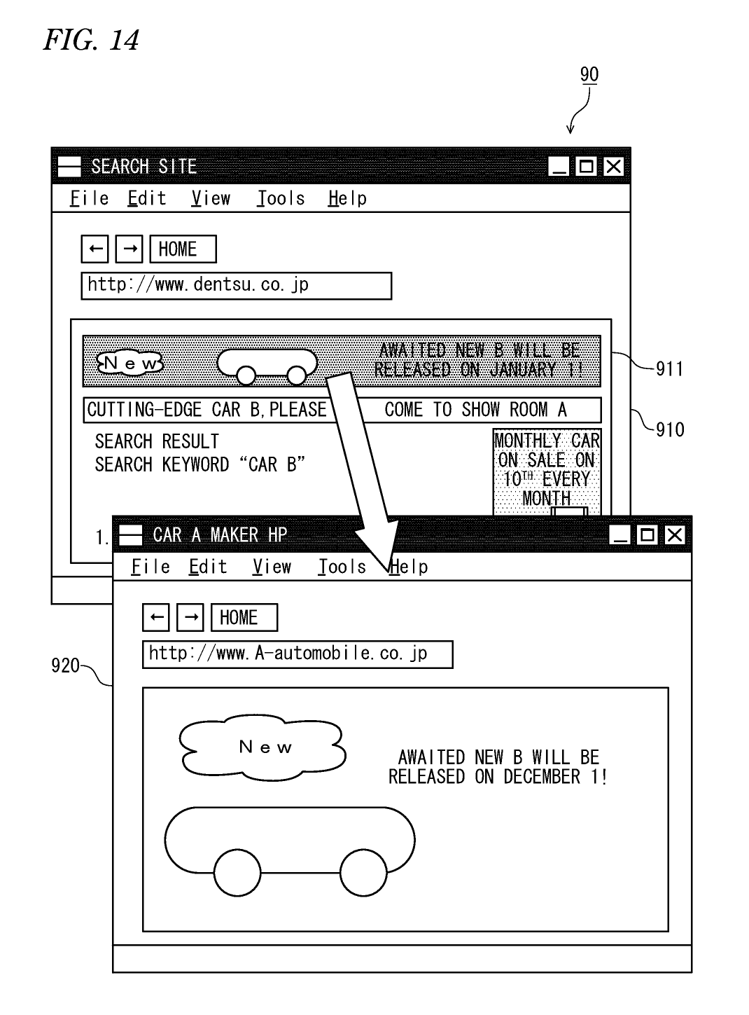

FIG. 15 is a configuration diagram of an advertisement recognition processing mechanism.

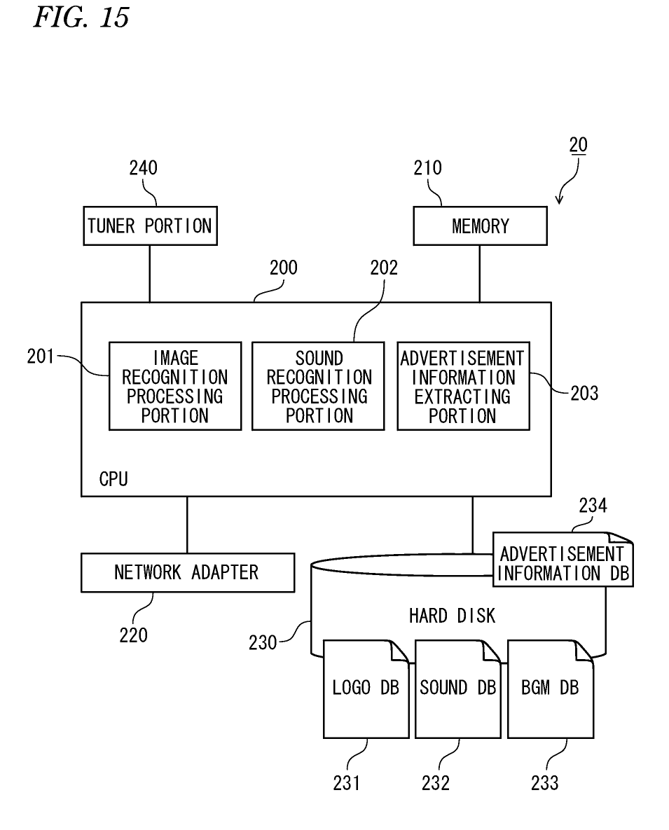

### EXPLANATION OF REFERENCE NUMERALS

10 listing advertisement transmitting device
100 CPU
101 clocking portion
102 advertisement frequency estimation portion
103 advertisement reach estimation portion
104 communication portion
105 advertisement transmission portion
107 display-mode parameter setting portion
108 user action acquisition portion
109 advertisement effectiveness determination portion
110 network adapter
120 hard disk
121 advertisement information database
122 advertisement condition database
123 listing condition database
130 monitor
140 keyboard
150 memory

1. A listing advertisement transmitting device connected to a user terminal device through a network and displaying listing advertisements where the advertised rates differ depending on a display mode at the user terminal device, comprising:
a broadcast information database storing broadcast information relating to at least broadcast contents and broadcast time of broadcast programs delivered on a wired or wireless broadcast medium intended to be directly received by the public in storage means;
an advertisement condition database storing in the storage means corresponding advertisement data and transmission conditions thereof according to the broadcast contents;
a listing condition database storing listing conditions relating to the display mode and the advertising rate in the storage means, the transmission conditions including at least a condition relation between the broadcast information and a current time;
display-mode parameter setting means for setting a display mode parameter including the display mode and the advertising rate according to the listing condition if the current time obtained from clocking means satisfies the transmission condition; and
advertisement transmitting means for transmitting the advertisement data from the advertisement condition database to the user terminal device through the network according to the display mode parameter.

2. The listing advertisement transmitting device according to claim 1, including cases where the broadcast programs are broadcast shows of news, sports, performance, entertainment, discussion and the like.

3. The listing advertisement transmitting device according to claim 2, further comprising goods information extracting means for extracting information on goods relating to goods or service from broadcast contents of a broadcast show if the broadcast program is a broadcast show, wherein
the extracted information is used as advertisement contents, the broadcast information at that time as advertisement information, and the broadcast information database at that time as an advertisement information database.

4. The listing advertisement transmitting device according to any one of claims 1 to 3, wherein a case in which the broadcast program is an advertisement is included, and in which case, the broadcast contents are advertisement contents, the broadcast information is advertisement information, and the broadcast information database is the advertisement information database.

5. The listing advertisement transmitting device according to claim 3 or 4, further comprising:
advertisement effectiveness determining means for determining advertisement effectiveness of an advertisement transmitted on the broadcast medium from at least the advertisement information; and
listing condition setting means for setting or updating the listing condition according to a determined result of the advertisement determining means.

6. The listing advertisement transmitting device according to claim 5, further comprising:
user action acquisition means for acquiring action information of a user to the listing advertisement, wherein
the advertisement effectiveness determining means determines the advertisement effectiveness from the advertisement data, the display mode parameter when the data is transmitted and the action information.

7. The listing advertisement transmitting device according to any one of claims 1 to 6, further comprising:
at least either one of receiving means for receiving the broadcast, image recognition means for image/video received by the receiving means or sound recognition means for sound received by the receiving means; and
advertisement information extracting means for extracting at least advertisement contents from a recognition result of the image recognition means or sound recognition means, wherein
the advertisement information is stored in the broadcast information database simultaneously with the broadcast.

8. The listing advertisement transmitting device according to any one of claims 1 to 7, wherein the broadcast media is TV broadcast or radio broadcast.

9. The listing advertisement transmitting device according to any one of claims 1 to 8, wherein the advertisement data is at least any one of text data, image data, video data or sound data constituting listing advertisement.

10. The listing advertisement transmitting device according to any one of claims 1 to 9, wherein the network is the Internet.

11. The listing advertisement transmitting device according to any one of claims 1 to 9, wherein the network is a cellular phone line or PHS phone line and the user terminal device is a phone terminal thereof.

12. The listing advertisement transmitting device according to any one of claims 1 to 11, wherein the listing advertisement transmitting device is a search site server provided with a search engine of the Internet, and the advertisement data is presented on the search site screen.

13. A listing advertisement transmitting method of a computer in a listing advertisement transmitting device connected to a user terminal device through a network and displaying listing advertisements where the advertised rates differ depending on a display mode at the user terminal device, comprising:
an advertisement information database storing broadcast information in the storage means, relating to at least broadcast contents and broadcast time of broadcast programs delivered on a wired or wireless broadcast medium intended to be directly received by the public;
an advertisement condition database storing in the storage means corresponding advertisement data and transmission conditions thereof according to the broadcast contents; and
a listing condition database storing listing conditions relating to the display mode and the advertising rate in the storage means in advance, the transmission conditions including at least a condition relation between the broadcast information and a current time, wherein
a display-mode parameter setting step in which display-mode parameter setting means of a computer sets a display mode parameter including the display mode and the advertising rate according to the listing condition if the current time obtained from clocking means satisfies the transmission condition; and
an advertisement transmission step in which advertisement transmitting means of a computer transmits the advertisement data from the advertisement condition database to the user terminal device through the network according to the display mode parameter are provided.

14. The listing advertisement transmitting method according to claim 13, including cases where the broadcast programs are broadcast shows of news, sports, performance, entertainment, discussion and the like.

15. The listing advertisement transmitting method according to claim 14, further comprising a goods information extracting step in which goods information extracting means of a computer extracts information on goods relating to goods or services from broadcast contents of a broadcast show before the advertising transmission step if the broadcast program is a broadcast show, wherein
the extracted information is used as advertisement contents, the broadcast information at that time as advertisement information, and the broadcast information database at that time as an advertisement information database.

16. The listing advertisement transmitting method according to any one of claims 13 to 15, wherein a case in which the broadcast program is an advertisement is included, and in that case, the broadcast contents are advertisement contents, the broadcast information is advertisement information, and the broadcast information database is the advertisement information database.

17. The listing advertisement transmitting method of a computer according to claim 15 or 16, wherein advertisement effectiveness determining means of a computer has an advertisement effectiveness determination step for determining advertisement effectiveness of an advertisement transmitted on a broadcast medium at least from the advertisement information; and
a listing condition setting step in which listing condition setting means of a computer sets or updates the listing condition according to a determined result of the advertisement determining means.

18. The listing advertisement transmitting method of a computer according to any one of claims 15 to 17, wherein user action acquisition means of a computer has a user action acquisition step for acquiring user action information relating to the listing advertisement; and
an advertisement effectiveness determination step for determining advertisement effectiveness from the advertisement data, the display mode parameter when the data is transmitted and the action information, and the listing condition setting step is executed.

19. The listing advertisement transmitting method of a computer according to any one of claims 13 to 18, further comprising:
at least any one of a broadcast receiving step in which the receiving means receives the broadcast, an image recognition processing step in which image recognizing means of a computer recognizes a received image/video, or a sound recognition processing step in which sound recognition means of a computer recognizes received sound: and
a broadcast information extracting step in which broadcast information extracting means of a computer extracts at least broadcast contents from a recognition result, wherein the broadcast information is stored in the broadcast information database simultaneously with the broadcast.

20. The listing advertisement transmitting method according to any one of claims 13 to 19, wherein the broadcast media is TV broadcast or radio broadcast.

21. The listing advertisement transmitting method according to any one of claims 13 to 20, wherein the advertisement data is at least any one of text data, image data, video data or sound data constituting the listing advertisement.

22. The listing advertisement transmitting method according to any one of claims 13 to 21, wherein the network is the Internet.

23. The listing advertisement transmitting method according to any one of claims 13 to 21, wherein the network is a cellular phone line or PHS phone line and the user terminal device is phone terminal thereof.

24. The listing advertisement transmitting method according to any one of claims 13 to 23, wherein the listing advertisement transmitting device is a search site server provided with a search engine of the Internet, and the advertisement data is presented on the search site screen.
